(19) United States
(12) Patent Application Publication
(10) Pub. No.: US 2013/0178151 A1
(43) Pub. Date: Jul. 11, 2013

(54) SAFE MOBILE CELLULAR PHONE PRIMARILY FOR CHILDREN

(71) Applicant: Eliyahu Itzhaki, Rehovot (IL)

(72) Inventor: Eliyahu Itzhaki, Rehovot (IL)

(21) Appl. No.: 13/346,744

(22) Filed: Jan. 10, 2012

(51) Int. Cl. H04W 4/00

(52) U.S. Cl. 455/26.1

(57) ABSTRACT

A safety portable cellular phone which has a plurality of states which are automatically selected according to a predefined set of instructions in order to lower the amount of radio frequency emissions emitted from the cell phone. The safety cell phone further includes a set of safety features to prevent wireless communications with unauthorized contacts.

### FIELD AND BACKGROUND OF THE INVENTION

The present invention relates to a mobile communication device and, more particularly, to a cell-phone which is safer than legacy cell phones for use for children.

The ubiquitous use of cellular phones has spawned an industry of safety measures and devices design to protect users from the potential damages (whether physical, psychological or medical) of cell-phones. Numerous studies have been conducted over the last three decades since first “portable cell phones” reached the market. Advances in technology are continually changing the way that cell-phones are built and work. Furthermore, demographic patterns of cell-phone use have changed so radically that studies are both incomplete and inconclusive as to the dangers of cell phone use. One common tenet of many studies is that younger users with developing skeletal structure and brains should minimize use and exposure to cell-phones, due to potential health risks. In the US, mobile phones are regulated by the Federal Communications Commission (FCC), which established rules on how much radiation cell phones can legally emit in 1996. The limits are based on specific absorption rate (SAR) values, which measure the rate at which energy is absorbed by body tissue. The permissible amount of radiation depends on the part of the body: head: up to 1.6 W/kg; whole body: up to 0.08 W/kg; hands, wrists, feet, and ankles: up to 4 W/kg.

Aside from potential health risks, whether empirically substantiated or not, there exists the very real risk of psychological and even physical damage from child predators, who are quick to use any methods available to prey on young victims. The National Association to Prevent Sexual Abuse of Children warns that predators can be ‘grooming’ potential victims without any outwardly obvious tell-tale signs, by using cell-phones. Predators can call, text, email, IM (instant message), have video calls and send pictures and videos over the device. The predator-prey interactions have detrimental psychological effects on the victims, not to mention the potential further danger of leading actual physical and sexual abuse.

Various attempts have been made to reduce some of the risks involved in cell-phone use. French Pat. Application FR 2886087 to Bohbot describes a mobile telephone terminal, for use by e.g. a child, that has a parental control and non-active operation mode in which only radio reception is active for receiving a message, and that returns the terminal to active mode for reception and emission of calls. Bohbot suffers at the least the drawback of the user not being able to electively emit a call or send a text message (SMS) when the terminal is in non-active operation mode. Furthermore, in all modes (excluding when the terminal is deactivated) the terminal substantially constantly emits radio emissions to check for message signals. Still further drawbacks include the scenario where the parents trust the child and therefore do not activate the parental control, resulting in the standard substantially constant emissions of radio frequency (RF) waves, in a manner similar to an un-protected cell phone. Bohbot attempts to provide a solution for increased parental control while minimizing battery usage.

US Pat. Pub. No. 2005/0233780 to Jani et al. teaches a system and method for power management in a mobile communications device. This disclosure, which is incorporated by reference for all purposes as if fully set forth herein, teaches a system for reducing power usage in a device when battery power is low. The power management system does not provide protection for a young user; rather the system conserves power when the battery is low while allowing full function while the battery is fully charged. Furthermore, in no way does the system of Jani et al. protect a young user from potential child predators.

It would be highly advantageous to have a portable cell phone which protects young users from health as well is physical/psychological dangers related to cell phone use, by providing a device with minimal radio wave emissions as well as parental controls aimed at keep the user safe from predators.

### DEFINITION

“Profile”—refers to a predefined set of features which are either enabled or disabled. For example the ‘meeting’ profile activates the vibrating feature while deactivating the ringer so that when a call comes through to the cell phone, the device vibrates but does not ring.

“State”—like a profile, a state refers to a predefined set of features which are either enabled or disabled. Unlike profiles which generally relate to the audio/visual/tactile features of a device (i.e. changes in a device that can be seen felt or heard), states related to enabling/disabling features which change the amount of radio emissions emitted from a device. A further distinction between states and profiles is that profiles are electively selected whereas the election of states is automatically controlled.

“Mode”—refers herein to the state of a mobile device wherein certain profiles are available. For example, Child Mode may include three specific states (e.g. ‘idle’, ‘active’, ‘message only’). A mode may be set as a factory setting, a parental setting or an elective setting.

### SUMMARY OF THE INVENTION

According to the present invention there is provided a safety portable cellular phone, including: (a) a non-volatile memory wherein is stored a set of instructions for placing the safety portable cellular phone reversibly in each of a plurality of states, wherein each of the plurality of states effects a unique configuration for the safety portable cellular phone; and (b) a controller configured to execute the instructions to place the safety portable cellular phone in one of the selected states, wherein the set of instructions includes instructions to limit radio frequency emissions from the safety portable cellular phone.

According to further features in preferred embodiments of the invention described below the set of instructions is included in an operating system of the safety portable cellular phone.

According to still further features in the described preferred embodiments the set of instructions is stored in a Read-Only Memory of the safety portable cellular phone, potentially programmed into the phone at the time of manufacture.

According to still further features in the described preferred embodiments the set of instructions is stored in a read/write memory of the safety portable cellular phone, e.g. in a mobile app, such as one that can be downloaded from the Internet and installed on a smartphone.

According to still further features the plurality of states includes at least: (i) an active state; (ii) an idle state; and (iii) a message-only state.

According to still further features when the active state is selected, the safety portable cellular phone is configured to effect wireless communications.

According to still further features when the idle state is selected, the safety portable cellular phone is configured to inhibit wireless communication.

According to still further features when the idle state is selected, the safety portable cellular phone is configured to inhibit wireless communication excluding Bluetooth wireless communication.

According to still further features when the idle state is selected, the safety portable cellular phone is configured to inhibit wireless communication excluding WiFi wireless communication.

According to still further features when the idle state is selected, the safety portable cellular phone is configured to inhibit wireless communication excluding Global Positioning System (GPS) wireless communication.

According to still further features when the message-only state is selected, the safety portable cellular phone is configured to periodically request messages from a base station via wireless communication.

According to still further features when a call-back function is triggered on the safety portable cellular phone, the safety portable cellular phone is configured to initiate a call-back communication, wherein the call-back function is triggered when a message including call-back information is received by the safety portable cellular phone from a priority contact.

According to still further features wherein when a time-limit function is activated on the safety portable cellular phone, the safety portable cellular phone is configured to sever a connection to a wireless network after a predetermined amount of time.

According to still further features the predetermined amount is time is counted from an initiation time of the connection to the wireless network or the predetermined amount is time is counted from a time that the connection to the wireless network becomes idle.

According to still further features when a signal-strength function is activated on the safety portable cellular phone, the safety portable cellular phone is configured to sever a connection to a wireless data network when a signal from the wireless data network is weak.

According to still further features the safety portable cellular phone further includes: (c) a non-volatile memory wherein is stored instructions including a set of safety features, configured to prevent the safety portable cellular phone from effecting unauthorized communications.

According to still further features effecting unauthorized communications includes: (i) initiating wireless communications with an unauthorized contact; and (ii) accessing received wireless communications from an unauthorized contact. According to still further features the set of safety features includes a filter feature, which is configured to effect at least one function selected from the group including: (i) a blocking function configured to block access to incoming communications that originate from an unapproved source; (ii) a logging function, configured to log communications blocked by the blocking function; (iii) a code checker function, configured to search communications blocked by the blocking function for a predefined approval code, wherein a blocked communication including the predefined approval code is unblocked; and (iv) an Internet filter, for filtering Internet access from the safety portable cellular device.

According to still further features the set of safety features includes a remote monitoring and updating feature, the remote monitoring and updating feature including functions selected from the group including: (i) remote updating, for allowing remote updating of an Approval List of approved contacts, wherein the Approval List is stored on the safety portable cellular phone; (ii) remote notification, for sending a notification communication to a supervisory contact regarding changes made to the Approval List; (iii) log sending, for sending a copy of a communication log to the supervisory contact;

### BRIEF DESCRIPTION OF THE DRAWINGS

Various embodiments are herein described, by way of example only, with reference to the accompanying drawings, wherein:

FIG. 1 is an exemplary cellular network;

FIG. 2 is a partial block diagram of a mobile device including a Protection Module of the current invention;

FIG. 3 is a work flow of a cellular network system according to an exemplary embodiment of the invention.

### DESCRIPTION OF THE PREFERRED EMBODIMENTS

The principles and operation of a child-protected cell phone according to the present invention may be better understood with reference to the drawings and the accompanying description.

Registration

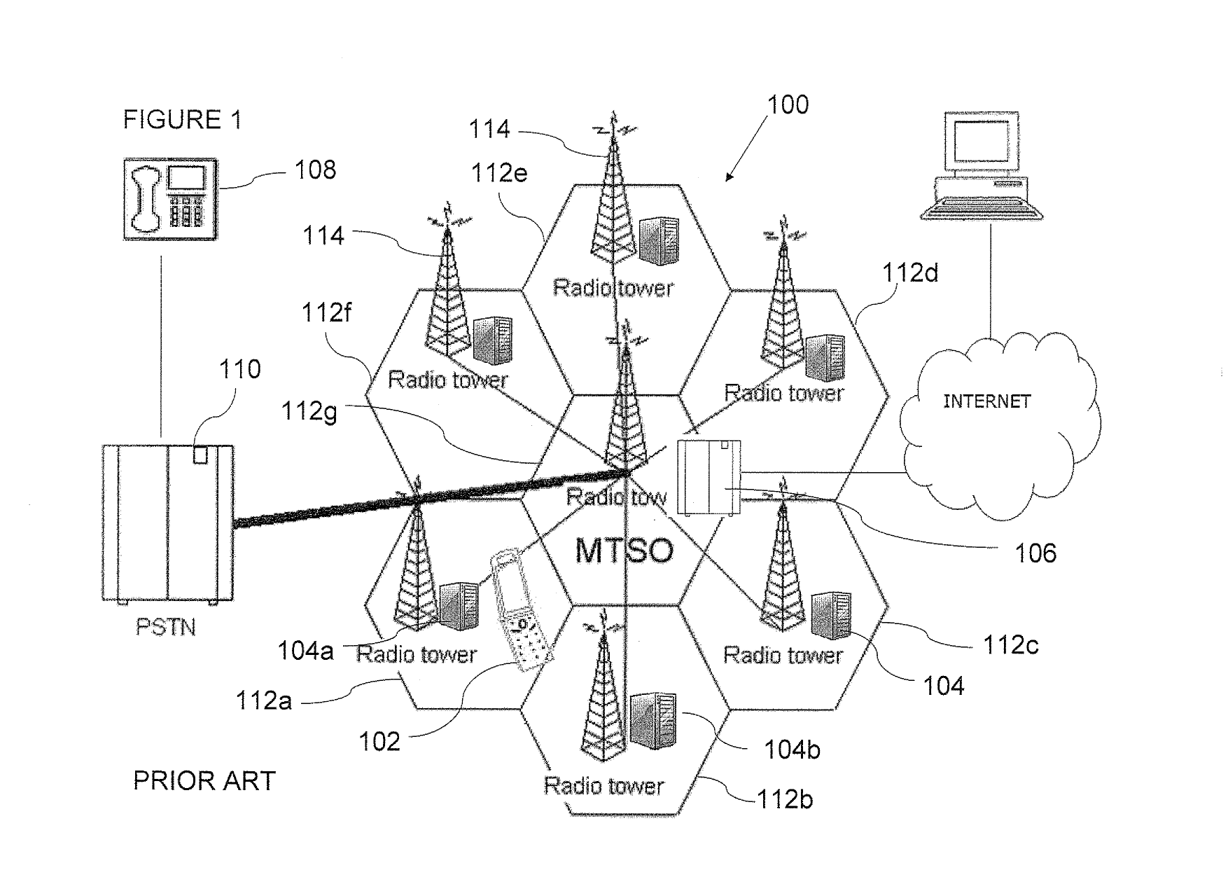

Referring now to the drawings, FIG. 1 illustrates an exemplary cellular network 100. When first powered up, a cell phone 102 listens for a System Identification Code (SID—a unique 5-digit number that is assigned to each carrier by the FCC) on the control channel. The control channel is a special frequency that the phone and a base station 104 utilize to communicate with one another regarding technical setup issues such as call set-up and channel changing. When the cell phone 102 receives the SID, the cell phone 102 compares the received SID to the SID programmed into the device. If the SIDs match, the device knows that the cell 112 it is communicating with is part of the home system.

Each carrier in each city, aside from the cell towers 114, also runs one central office called the Mobile Telephone Switching Office (MTSO) 106. This office handles all of the phone connections to the normal land-based phone system 108 via a Public Switched Telephone Network (PSTN) 110, and controls all of the base stations 104 in the region. Along with the SID, the phone also transmits a registration request, and MTSO 106 keeps track of the location of device 102 in a database. In this manner, MTSO 106 knows which cell device 102 is in and can route calls to the device. When MTSO 106 receives a call, the database is searched for location of device 102. MTSO 106 then selects a frequency pair for the device to use in that cell 112 to transmit the call.

MTSO 106 communicates the frequency information over the control channel to cell phone 102 enabling the cell phone to switch to the call frequency and receive the communication. When the device moves to the edge of cell 112a range, base station 104a detects that the signal strength is diminishing. At the same time base station 104b in adjacent cell 112b, towards which the phone is moving, detects the phone signal strength increasing. The two base stations coordinate with each other through the MTSO, and at some point, the cell phone receives a signal on a control channel instructing the device to change frequencies. This hand off between the cell base stations switches the phone to the new cell.

A mobile phone runs a self diagnostic when powered up. Once the self diagnostic is completed the phone acts like a scanning radio, searching through a list of forward control channels, picking the one with the strongest signal, which is usually provided by the nearest base station. The mobile communication device re-scans every seven seconds or when signal strength drops below a pre-determined threshold. Registration is an ongoing process. Moving from one service area to another causes registration to begin again. Additionally, registration is performed periodically as an automatic activity of the system to update the status of the mobile communication device. The base station may also initiate registration on its own by sending a signal to the mobile communication device forcing the device to transmit and to identify itself. Registration also takes place just before a call is placed.

RF Emission Protection

All of the aforementioned activities, scanning, registration, transmitting a signal etc. involve the handheld device emitting RF energy, some of which is absorbed into the body of the user holding the device. The current invention reduces the aforementioned emissions by changing the manner in which the cell phone operates when used by a young individual. It is of course understood that any individual can use the innovative device, and that the device may not be specifically geared only for use by children, but rather for adult users as well. In one preferred mode of operation the cell phone has a factory-defined profile (e.g. ‘Child’) which can be electively selected either during the initial setup of the cell phone after purchase or at any time with the use of a parental code. Alternatively, a mobile application, installed on a mobile device, can control the mobile device when activated. The mobile application (app) when activated, preferably by a parent or guardian, controls the mobile device in a ‘Child’ mode, which is substantially equivalent to the ‘Child’ profile, mentioned heretofore. A further alternative is a dedicated device which is based on a specialized operating system created for the purpose of the current innovation, or based on known operating systems (e.g. such as an iOS™ or Android™) where the operating system has been modified or is being used to install a 3^{rd} party application to only allow operation in the manner described herein. In one potential embodiment the dedicated device may be used for young individuals (i.e. children) whereas a mobile app may be installed for used by an adult. It follows that the ‘predator protection’ features may be optionally activated or deactivated (or not included at all, i.e. one mobile app for young users and a second app for adult users) in the mobile app.

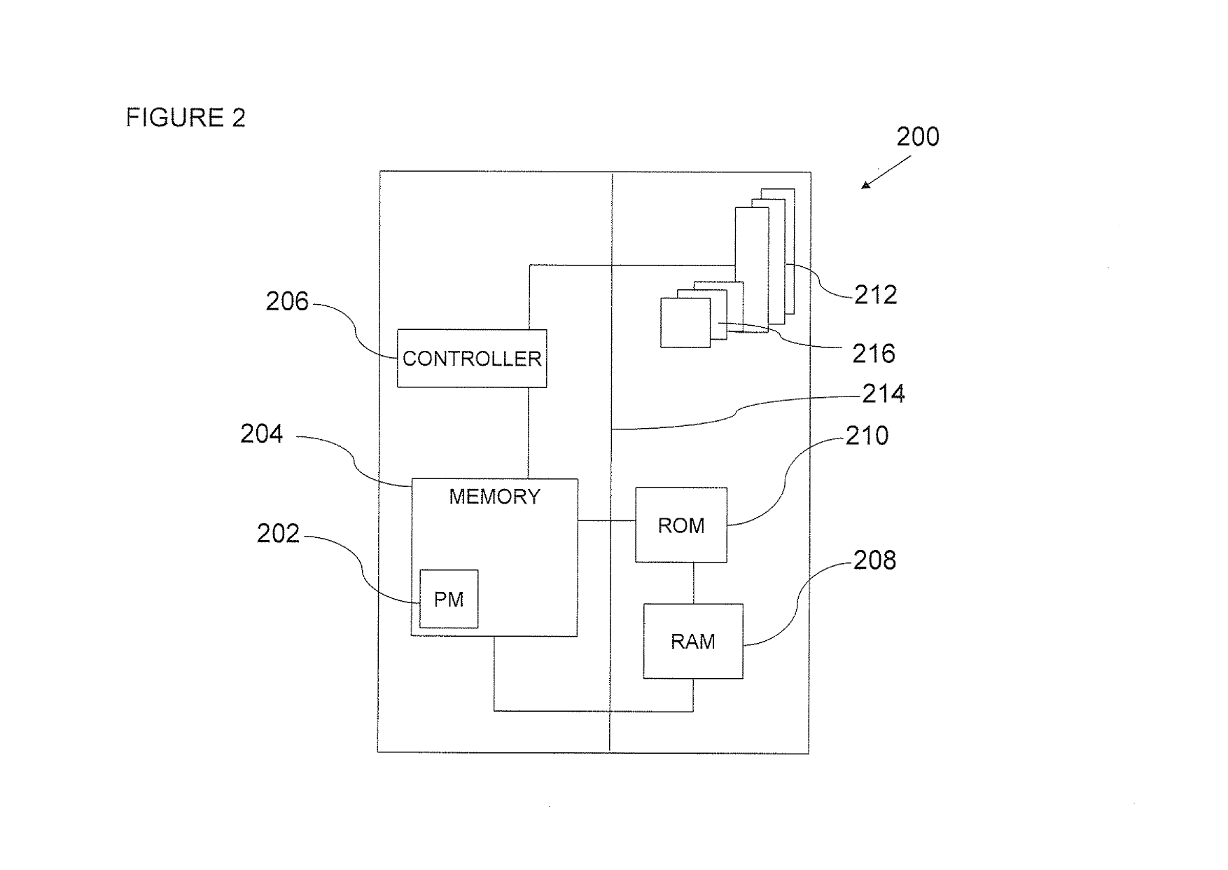

Referring now to FIG. 2, FIG. 2 is a partial block diagram of a mobile device including a Protection Module (PM) 202 of the current invention. The Protection Module 202 is a software module stored in the storage unit/memory 204 of the mobile device either during manufacture or at a later stage when downloaded in the form of a mobile app. Either way, the Protection Module 202 includes instructions embedded on a computer-readable medium which, when implemented by a processor/microcontroller 206 of the mobile device 200, causes the processor to carry out the functions described below for the Child profile/mode. In general, when PM 202 is accessed, the program is loaded from a non-volatile memory 204 (e.g. Flash memory) into RAM 208 and is executed by processor 202 which is usually (but not limited to) an Application-Specific Integrated. Circuit (ASIC). In the embodiment including a Child profile, ROM 210 may include the instructions otherwise found in PM 202. RF emissions emanate mainly from the antenna or antennas 212 (a plurality of antennas 212 have been depicted in FIG. 2 although a single antenna may to incorporate a number of antenna functions for cellular radio for voice and data as well as GPS, WiFi, BlueTooth and any other wireless components included in the mobile device 102). The transmitted radio frequencies are generated by transmitters 216. Usually each wireless communication component, such as BlueTooth, GPS, WiFi etc. has a dedicated transmitter/transceiver 216 whereas the antennas for the components may be integrated into a single antenna (e.g. as is the case with the iPhone™ 4 series). All the units mentioned here are connected by a bus 214. It is clear that only relevant parts of the cell phone of the immediate innovation have been included in the diagram.

Reference is now made to both FIGS. 1 and 2. Preferably, when the Child profile/mode is activated, radio emissions are significantly reduced in one or more of the following manners: When not in active use by the owner, all RF emissions from the device are stopped. Cell phone 102 does not register with base station 104 and therefore may not receive any transmissions from the base station, especially if the user has moved into a different cell 112 without registering with the new base station. Any heretofore active wireless connections are severed and the transmitters 212 are deactivated. Therefore, a Wi-Fi transceiver 216 is deactivated and the device desists from actively searching for Wi-Fi and radio signals. A BlueTooth (BT) transmitter 216 is deactivated, severing any existing connections. Preferably administrative settings are protected with a parental code. Global Positioning System (GPS) transceivers 216 are deactivated and no longer send or receive signals. Of course, in some embodiments, BT communication and/or WiFi communication and/or GPS communication may continue unhindered, according to administrative settings.

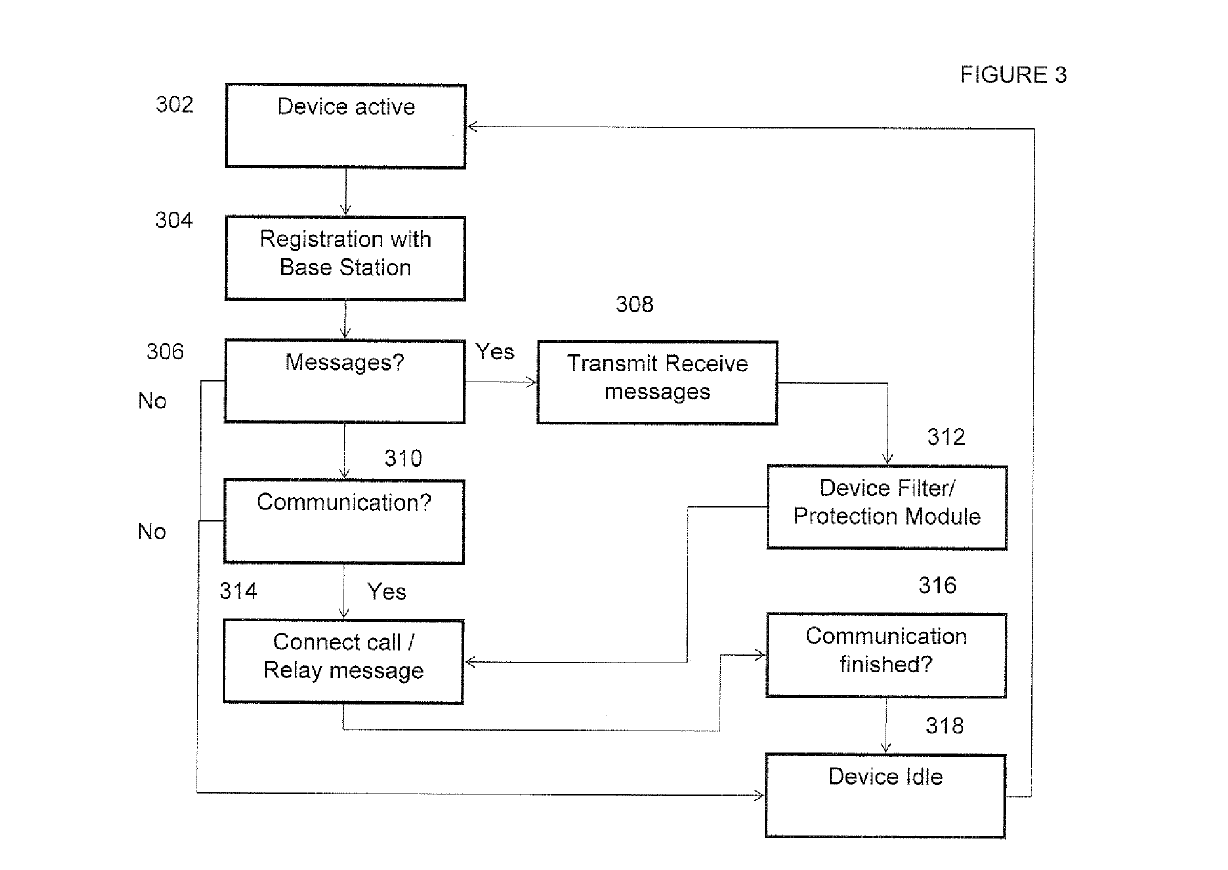

FIG. 3 is a work flow of a cellular network system according to an exemplary embodiment of the invention. When device 102 is not actively in use (e.g. the user is not initiating or participating in an active communication), the device generally cannot receive communications from a base station as the device 102 does not register with the base station. Information regarding calls which are not connected (i.e. ‘missed calls’) is stored on the base station server 104 which has the latest registration information (i.e. the last base station 104 to receive a registration signal from device 102). Voice messages are likewise stored on the message server 104 of the base station. In a similar fashion, text and multimedia messages sent to the idle or inactive device are stored on the message server of the base station proximal to the last known location of the mobile device. Therefore, when the device is activated (e.g. in order to make a call or send an SMS or the like) in step 302 (FIG. 3) the device registers with the nearest base station 104 (step 304). The device checks for messages (step 306) and, if found, the base station forwards all the messages (missed calls information, SMS and other stored messages) to the device (step 308) prior to initiating the communication, (step 310) or immediately after terminating the communication (or, less preferably, during the communication). Alternatively or additionally the message/s may be sent via a method besides SMS, for example, a service/system message sent directly to the device not via an SMS message server, or via an email which is downloaded when the user connects to the Internet, or a service/system message that is automatically downloaded when the device connects to the Internet. If the user (generally assumed to be a child, but not necessarily) has changed location since the last registration, the local base station (e.g. 104b) may have to check with the MTSO 106 to get the stored information from the base station (e.g. 104a) proximal to the last known location. Messages received by device 102 are filtered by Protection Module 212 (step 312). If deemed safe (more detail below), then the messages become available to the user (step 314). If a message is not deemed safe, then it is blocked from the user. Similarly, the ‘call-back’ function, discussed in further detail below, can be activated at this point to initiate a call-back communication. Once the communication has been terminated (e.g. the call has ended or the text message has been sent etc) in step 316, the device returns to the idle state (step 318) until such a time at which the device is activated again (step 302).

Optional Periodic Registration

In some embodiments, even when the cell phone is idle (i.e. non-emission mode) the cell phone may periodically register with the base station 104 (step 304) to check for messages (step 306). If there are messages, the messages are transmitted to device 102 (step 308). If no messages are stored, the device return to the idle state (Step 318). In some embodiment, the device may check for incoming communications (step 310) before going into the idle state (step 318) This periodic check may be factory defined or user defined, and work in a manner similar to that of conventional email applications which check for emails every 10 or 15 minutes. In still further embodiments, the registration signal may have a very low frequency and duration, only checking for priority messages, such as messages originating from a parent. This ensures that the child if not out of communication for more than 10 or 15 minutes. In some embodiments, priority messages indicating that a parent attempted to phone the child, may trigger an automatic initiation of a call to the parent. The mobile app, receiving the call information (from the base station during a priority check) can initiate a call-back communication to the priority/supervisory contact (e.g. the parent), where the phone rings by the priority contact and, when answered, begins to ring on the child end (or vice versa). A priority contact may by the supervisory contact (i.e. the parent or guardian) or some other predefined contact in the Approved List. More than one contact may be defined as a priority contact.

With smartphones (which have Internet connectivity), when in Child profile, Internet access may only be allowed through a filtered environment or child-friendly portal (a further discussion in this topic can be found under the ‘Predator Protection’ section). Regardless of the type of environment available via the connection, the wireless Internet communication may be limited in a number of manners: Connection to the Internet may be limited by a pre-defined time limit. This prevents or restricts continual use of wireless Internet capability offered by 3^{rd} generation and later cell phones. Often, in conventional smartphones, a connection is not severed at the end of use and the handheld device continues to emit RF radiation unchecked. The innovative time-limit feature reduces these needless emissions. The time-limit feature have a standardized (i.e. the counter begins as soon as a connection is made) or relative (e.g. when the connection is idle, i.e. no use of the device or the browser is detected for a predefined number of seconds, then the clock starts) nature. This feature may also prevent the wireless connection running in the background while the child is using the device for other purposes (such as listening to music or playing a game).

Alternatively, connection to the Internet or any other wireless data network may be limited according to signal strength. Cellular device are configured to boost RF emissions when the signal strength from a cell tower/base station is low/weak in order to maintain the connection. Therefore, limiting connectivity according to signal strength (i.e. only allowing connectivity in areas with a strong signal and disallowing connectivity in areas with a weak signal) further minimizes RF emissions. For the purposes of the current disclosure, a ‘weak’ signal is a signal that causes a cellular device to boost RF emission levels. Although the same concept/feature could be applied to calls, this is not practical and significantly curtails the regular use of the device, i.e. as a communication device for electively making calls:

Predator Protection

In order to further protect the young user, the cell phone further includes software modules, embodied in a mobile phone application (app), or alternatively embodied in the factory manufactured programs installed on the cell phone or further alternatively embodied in the base programming or operating system of the cell phone. In step 312 of the flow depicted in FIG. 3, the mobile app/PM 202 acts as a filter function for incoming calls and messages. The device includes an editable directory of approved contacts in an Approved. List. The directory is protected by a code that should be known only to the parent or guardian of the child. In some embodiments, in place of an alpha/numerical code, a bio-information marker, such as facial recognition or finger print of the parent may be used to secure the directory. Any incoming voice or video calls, SMS messages, Instant Messages (IM), emails, MMS messages being received at the device is screened by the Filter feature/function. If the call or message originates from an approved source listed on the Approved List then the call or message is shown to the user. Otherwise the call or message is blocked. Potentially a log of blocked calls/messages can be send to the parent/guardian for perusal. If for some reason an allowed message was blocked, the parent/guardian can resend the message (‘Forward’ the message) to the child user.

Alternatively or additionally, any text based communication that includes a predefined approval code may be accepted as coming from an approved source. The mobile app/PM 202 checks the initial string (or some other predetermined segment of the message) in the message for the code, even if the address is not on the Approved List. If the initial string (or some other predetermined segment of the message) matches the code, then the message will be unblocked and visible to the child. In some embodiments, audio and or visual based communication may also include an embedded predefined approval code within the audio and/or visual communication. Likewise, only contacts on the Approved List can be the targets of outgoing communications.

Today, members of the younger generation are most often more technically savvy than their parent or guardian. This fact coupled with the fact that children often keep secrets from parents suggests that a child will try to add an illicit contact to the directory without the knowledge of the parent. Therefore in a preferred embodiment of the invention, the Approved. List is monitored and updated remotely by a device identified as the supervisory device for the given monitored device (i.e. the parental device is the supervisory device for the child device). Furthermore, any update to the directory results in notification to the parent/guardian via at least an SMS, I′M, email, voice message or any combination thereof. Therefore, if a child manages to update the directory by stealing the code or otherwise gaining unlawful access to the directory, at least the parent will be informed that a change has been made. If the parent made the change; all is good and well. If the parent did not make the change but receives a message that the directory has been updated, this will encourage the parent to investigate the matter. A copy of the un-editable communication log may also be sent periodically (e.g. daily at a predefined hour) to the parent, in order to encourage further supervision. The aforementioned security measures are designed to discourage and hopefully prevent a child from conducting illicit and potentially dangerous communications with individuals unknown.

As mentioned before, Internet access should only be allowed through a filtered environment or child-friendly portal. Here too, the allowed environment may be selected by the parent/guardian or factory-defined. Many Web-filters and child-friendly web-portals exist in the art. Unfortunately, parents only install these filters on home networks not realizing that capabilities of smartphones, which are essentially miniature computers with wireless connectivity to the Internet. Preferably, the mobile app includes a browser filter, preventing the child from ‘surfing’ the Internet unchecked.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A safety portable cellular phone, comprising:
(a) a non-volatile memory wherein is stored a set of instructions for placing the safety portable cellular phone reversibly in each of a plurality of states, wherein each of said plurality of states effects a unique configuration for the safety portable cellular phone; and
(b) a controller configured to execute said instructions to place the safety portable cellular phone in a selected one of said states,
wherein said set of instructions includes instructions to limit radio frequency emissions from the safety portable cellular phone.

2. The safety portable cellular phone of claim 1, wherein said set of instructions is included in an operating system of the safety portable cellular phone.

3. The safety portable cellular phone of claim 1, wherein said set of instructions is stored in a Read-Only Memory of the safety portable cellular phone.

4. The safety portable cellular phone of claim 1, wherein said set of instructions is stored in a read/write memory of the safety portable cellular phone.

5. The safety portable cellular phone of claim 1, wherein said plurality of states includes at least:
(i) an active state;
(ii) an idle state; and
(iii) a message-only state.

6. The safety portable cellular phone of claim 5, wherein when said active state is selected, the safety portable cellular phone is configured to effect wireless communications.

7. The safety portable cellular phone of claim 5, wherein when said idle state is selected, the safety portable cellular phone is configured to inhibit wireless communication.

8. The safety portable cellular phone of claim 5, wherein when said idle state is selected, the safety portable cellular phone is configured to inhibit wireless communication excluding Bluetooth wireless communication.

9. The safety portable cellular phone of claim 5, wherein when said idle state is selected, the safety portable cellular phone is configured to inhibit wireless communication excluding WiFi wireless communication.

10. The safety portable cellular phone of claim 5, wherein when said idle state is selected, the safety portable cellular phone is configured to inhibit wireless communication excluding Global Positioning System (GPS) wireless communication.

11. The safety portable cellular phone of claim 5, wherein when said message-only state is selected, the safety portable cellular phone is configured to periodically request messages from a base station via wireless communication.

12. The safety portable cellular phone of claim 1, wherein when a call-back function is triggered on the safety portable cellular phone, the safety portable cellular phone is configured to initiate a call-back communication, wherein said call-back function is triggered when a message including call-back information is received by the safety portable cellular phone from a priority contact.

13. The safety portable cellular phone of claim 1, wherein when a time-limit function is activated on the safety portable cellular phone, the safety portable cellular phone is configured to sever a connection to a wireless network after a predetermined amount of time.

14. The safety portable cellular phone of claim 9, wherein said predetermined amount is time is counted from an initiation time of said connection to said wireless network.

15. The safety portable cellular phone of claim 9, wherein said predetermined amount is time is counted from a time that said connection to said wireless network becomes idle.

16. The safety portable cellular phone of claim 1, wherein when a signal-strength function is activated on the safety portable cellular phone, the safety portable cellular phone is configured to sever a connection to a wireless data network when a signal from said wireless data network is weak.

17. The safety portable cellular phone of claim 1, further comprising:
(c) a non-volatile memory wherein is stored instructions including a set of safety features, configured to prevent the safety portable cellular phone from effecting unauthorized communications.

18. The safety portable cellular phone of claim 17, wherein said effecting unauthorized communications includes:
(i) initiating wireless communications with an unauthorized contact; and
(ii) accessing received wireless communications from an unauthorized contact.

19. The safety portable cellular phone of claim 17, wherein said set of safety features includes a filter feature, said filter feature configured to effect at least one function selected from the group including:
(i) a blocking function configured to block access to incoming communications that originate from an unapproved source;
(ii) a logging function, configured to log communications blocked by said blocking function;
(iii) a code checker function, configured to search communications blocked by said blocking function for a predefined approval code,
wherein a blocked communication including said predefined approval code is unblocked; and
(iv) an Internet filter, for filtering Internet access from the safety portable cellular device.

20. The safety portable cellular phone of claim 17, wherein said set of safety features includes a remote monitoring and updating feature, said remote monitoring and updating feature including functions selected from the group including:
(i) remote updating, for allowing remote updating of an Approval List of approved contacts, wherein said Approval List is stored on the safety portable cellular phone;
(ii) remote notification, for sending a notification communication to a supervisory contact regarding changes made to said Approval List; and
(iii) log sending, for sending a copy of a communication log to said supervisory contact; [symbol]
